(19) United States
(12) Patent Application Publication
(10) Pub. No.: US 2012/0268357 A1
(43) Pub. Date: Oct. 25, 2012

(54) DISPLAY PANEL

(75) Inventors: Ming-Chia SHIH, Miao-Li County (TW); Chih-Ting CHEN, Miao-Li County (TW); Chien-Hung CHEN, Miao-Li County (TW); Hsin-Yu LEE, Miao-Li County (TW); Hsin-Cheng HUNG, Miao-Li County (TW)

(73) Assignees: CHIMEI INNOLUX CORPORATION, Miao-Li County (TW); INNOCOM TECHNOLOGY (SHENZHEN) CO., LTD., Shenzhen City (CN)

(21) Appl. No.: 13/417,042

(22) Filed: Mar. 9, 2012

(30) Foreign Application Priority Data
Apr. 22, 2011 (TW) 100114004

(51) Int. Cl. G09G 3/36

(52) U.S. Cl. 345/88

(57) ABSTRACT

The invention provides a display panel. The display panel includes a plurality of pixels. Each pixel includes a first color sub-pixel, a second color sub-pixel, a third color sub-pixel, and a fourth color sub-pixel, and the first color sub-pixel consists of a light region and a dark region.

### CROSS REFERENCE TO RELATED APPLICATIONS

This application is based upon and claims the benefit of priority from the prior Taiwan Patent Application No. 100114004, filed on Apr. 22, 2011, the entire contents of which are incorporated herein by reference.

### BACKGROUND

1. Technical Field

The present invention relates to a display panel, and in particular relates to a display panel with low color shift when viewed from a side.

2. Description of the Related Art

As incident lights pass through a liquid crystal layer from different angles, different retardations are generated, wherein the refractive index of the light transmissions change according to different observation angles and as a result, a different transmittance and different brightness is observed when viewed from different angles.

In accordance with Gooch-Tarry's Law, light transmission is determined by the difference in a refractive index and the light pathway length. Since the liquid crystal is dielectric anisotropy and offers birefringence to an obliquely incident light, the polarized lights with various incident angels respectively have a corresponding difference in refractive index. Further, the light pathway lengths (passing through the liquid crystal layer) of the polarized lights with various incident angels are also distinct. Therefore, the brightness of light will change according to viewing angle.

Additionally, since light transmittance also depends on the wavelength of light, a color shift phenomenon will result when different colors of light (such as red light, green light, and blue light) are combined at a different brightness when viewed from the front and a side of an LCD. Consequently, how to effectively improve the color shift phenomenon when viewed color displays from both front and sides has become an important task.

A method for solving the aforementioned color shift problem has been provided. As shown in FIG. 1, each pixel 11 of the conventional liquid crystal display 10 has a plurality of sub-pixels (such as a red sub-pixel, a green sub-pixel G, and a blue sub-pixel B), and each sub-pixel is further divided into a pair of sub-subpixels (so-called “low color shift (LCS) structure”), such as two red sub-subpixels R1 and R2, two green sub-subpixels G1 and G2, and two blue sub-subpixels B1 and B2. The pair of sub-subpixels is respectively driven by a bright state display signal and a dark state display signal in order to provide a gray scale for displaying a desired color, thereby improving the color shift problem under large viewing angles and expanding the overall viewing angles. However, all sub-pixels (such as R/G/B sub-pixels) of the conventional liquid crystal display 10 have to be applied with the LCS structure for reducing hue shift and white point shift when being viewed from a side. Therefore, the amount of the thin film transistor, the gate line, the data line, and/or the capacitor may be doubled, thereby reducing the aperture ratio of the display and resulting in a display with a reduced brightness, a high energy consumption, or a high manufacturing cost.

Accordingly, a novel liquid crystal display which overcomes the aforementioned problems is desired.

### SUMMARY

The disclosure provides a display panel, wherein the display panel includes a plurality of pixels, wherein each pixel comprises a first color sub-pixel, a second color sub-pixel, a third color sub-pixel, and a fourth color sub-pixel, and the first color sub-pixel consists of a bright region and a dark region.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic diagram showing the arrangement of sub-pixels of a conventional liquid crystal display.

FIG. 2 is a schematic diagram showing the arrangement of sub-pixels of the display panel according to an embodiment of the disclosure.

FIG. 3 is a CIE coordinate diagram showing the improvement in color shift according to an embodiment of the disclosure.

FIGS. 4 and 5 are schematic diagrams showing the arrangements of sub-pixels of the display panels according to some embodiments of the disclosure.

FIG. 6 is a schematic diagram showing the arrangement of sub-pixels of the display panel according to another embodiment of the disclosure.

FIG. 7 is a layout diagram of the pixel 101 of the WRGB display panel according to Example 1 of the disclosure.

FIG. 8 is an equivalent circuit diagram of the white sub-pixel W of the pixel 101 shown in FIG. 7.

FIG. 9 is a layout diagram of the pixel 101 of the WRGB display panel according to Example 2 of the disclosure.

FIG. 10 is an equivalent circuit diagram of the white sub-pixel W of the pixel 101 shown in FIG. 9.

FIG. 11 is a schematic diagram showing the sub-pixel polarity arrangement of the WRGB display panel of Example 2.

FIG. 12 is a layout diagram of the pixel 101 of the WRGB display panel according to Example 3 of the disclosure.

FIG. 13 is an equivalent circuit diagram of the white sub-pixel W of the pixel 101 shown in FIG. 12.

FIG. 14 is a schematic diagram showing the sub-pixel polarity arrangement of the WRGB display panel of Example 3.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

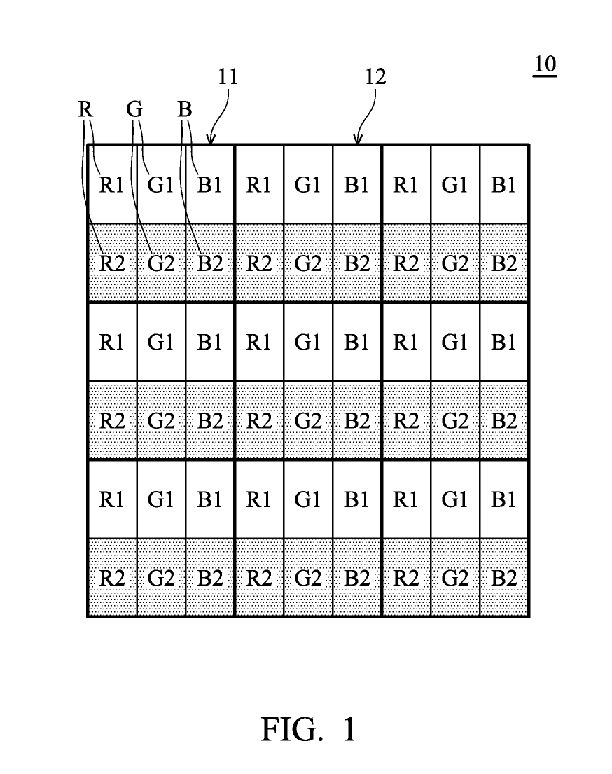

The disclosure provides a display panel for solving the problems of prior arts. The display panel includes a plurality of pixels, wherein each pixel includes a first color sub-pixel, a second color sub-pixel, a third color sub-pixel, and a fourth color sub-pixel. For example, the display panel can be a display panel with WRGB sub-pixels. Rather than apply the low color shift structure in all sub-pixels of the conventional display panel shown in FIG. 1, the disclosure applies the low color shift structure in at least one sub-pixel to at most three sub-pixels among the four sub-pixels of the display panel. Namely, at least one sub-pixel among the first, second, third and fourth sub-pixels (for example the fourth sub-pixel) does not have the low color shift structure. The sub-pixel without the low color shift structure consists of one region (uniform brightness) and is not divided into a bright region and dark region.

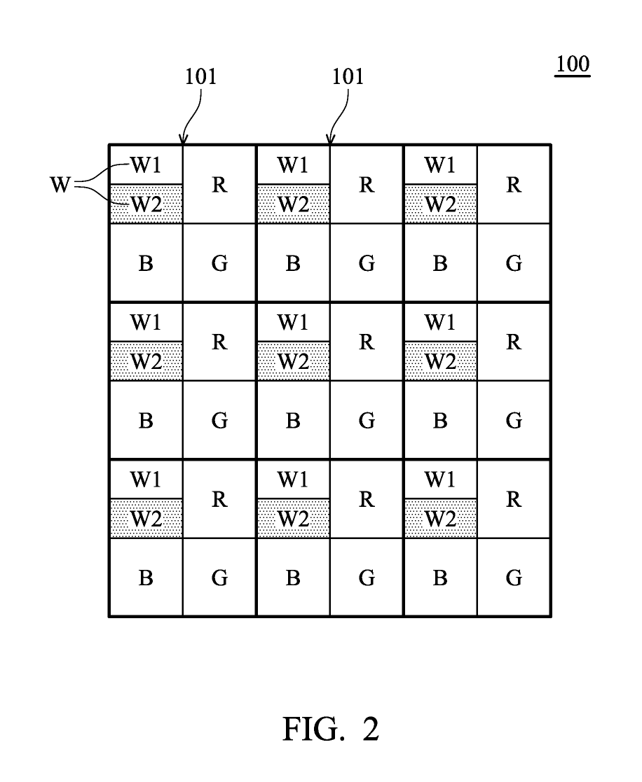

According to an embodiment of the disclosure, referring to FIG. 2, the display panel 100 includes a plurality of pixels 101 arranged as a matrix array. Each pixel 101 includes a white sub-pixel W, a red sub-pixel R, a green sub-pixel G, and a blue sub-pixel B. Particularly, the white sub-pixel W can have a low color shift structure and be divided into a bright region W1 and a dark region W2. The low color shift structure of the white sub-pixel W can be accomplished by a charge-sharing operation (C-S type) or a two transistor operation (T-T type). The white sub-pixel W can be divided into the bright region W1 and the dark region W2 during operation, achieving a low color shift display mode. Particularly, the area of the bright region W1 can be equal to or different from the area of the dark region W2.

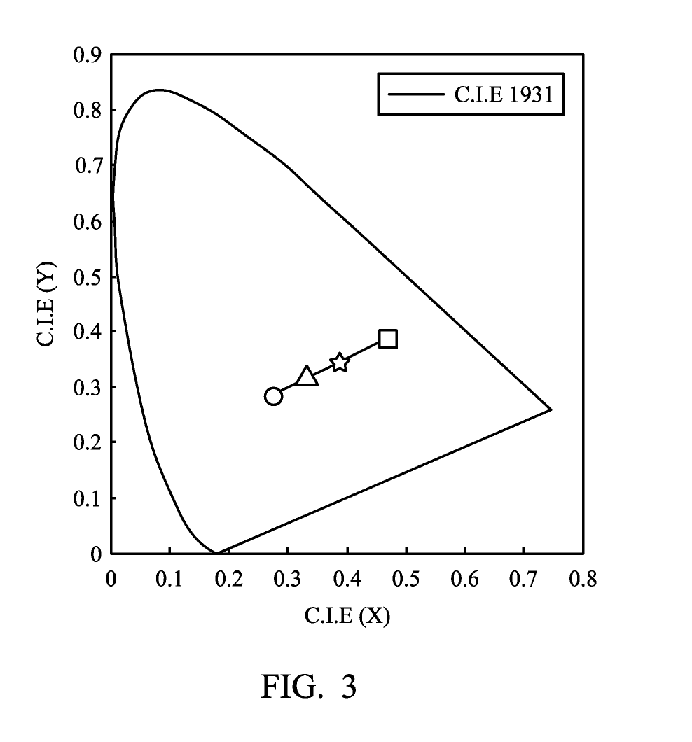

Please refer to FIG. 3, wherein a display panel with WRGB sub-pixels has a white point marked on the CIE coordinate diagram of a circle (an idea white color of the panel is substantiality equal to the white point, but there is an original difference between the fact white color of the panel and the white point). Further, a pixel of the panel has a specific color point marked on the CIE coordinate diagram of a square when viewed from the front. When viewed from a side, the specific color point shifts toward the white point CIE coordinate along a straight line from the specific color point CIE coordinate (square) when viewed from the front to the white point CIE coordinate (circle), and is marked on the CIE coordinate diagram of a triangle. In comparison with the specific color point (viewing from the front), the shifted specific color point (viewing from a side) has a lower color hue and exhibits a washout display appearance.

As shown in FIG. 2, the display panel with the white pixel having a low color shift structure can reduce the color shift of the specific color point when viewed from a side. Therefore, the specific color point shifting when viewed from a side (triangle) can be regulated toward the specific CIE coordinate when viewed from the front (square) along a straight line from the specific color point CIE coordinate (square) when viewed from the front to the white point CIE coordinate (circle) to improve the color hue. The improved specific color point is marked on the CIE coordinate diagram of a star.

Since the all sub-pixels of the conventional display panel have a low color shift structure (such as the display panel shown in FIG. 1), the conventional display panel has a greater improvement in color hue shifting in comparison with the display panel as shown in FIG. 2. However, in the conventional display panel, all sub-pixels (such as red, green, and blue sub-pixels for a RGB display panel, or white, red, green, and blue sub-pixels for a WRGB display panel) must be applied to a low color shift structure design, thereby reducing the aperture ratio, reducing the display brightness, and increasing the cost (due to a multiplied amount of thin film transistors, gate signal lines, data lines, and/or capacitors).

To the contrary, in the display panel of the disclosure, one of the white, red, green, and blue sub-pixels (such as the white sub-pixel) is applied to the low color shift structure design (divided into a bright region W1 and dark region W2), and an obvious improvement in color hue shifting is achieved. Namely, since only one-quarter of sub-pixels are applied to the low color shift structure design for improving color hue shifting and reducing the shifting of the white point, it means that only one-quarter amount of thin film transistors, gate signal lines, data lines, and/or capacitors is required in comparison with the conventional display panel, thereby increasing the aperture ratio and reducing the cost.

It should be noted that, in a display panel with RGB sub-pixels, if only one of the red, green, and blue sub-pixels is applied to the low color shift structure design, the color shift problem when viewed from a side would still be present and the color hue shifting when viewed from a side would be more serious. Accordingly, even black and white display modes would be colorful when viewed from a side. For example, if only a blue sub-pixel (for a RGB display panel) is applied to the low color shift structure design, a yellow-color shift would be observed when viewed from a side.

The aforementioned problem may also occur when applying the low color shift structure design to a red, green, or blue sub-pixel of a WRGB display panel. To the contrary, in the disclosure, the white sub-pixel W of the WRGB display panel is applied to the low color shift structure design (dividing the white sub-pixel W into a bright region W1 and dark region W2). Since the white sub-pixel is classified as a gray tone, the color hue shifting when viewed from a side is relatively eased.

According to the embodiment shown in FIG. 2, the white sub-pixel W, red sub-pixel R, green sub-pixel G, and blue sub-pixel B of the display panel 100 are arranged to form a square arrangement. The area of the white sub-pixel W, the area of the red sub-pixel R, the area of the green sub-pixel G, and the area of the blue sub-pixel B are equal to each other. According to some embodiments of the disclosure, the white sub-pixel W, red sub-pixel R, green sub-pixel G, and blue sub-pixel B of the display panel 100 can be arranged to form a striped arrangement, or a mosaic arrangement. The various pixel arrangements can be selected to match the low color shift structure, thereby achieving aperture ratio optimization.

For example, when the white sub-pixel W, red sub-pixel R, green sub-pixel G, and blue sub-pixel B of the WRGB display panel are arranged to form a striped arrangement, the low color shift structure of the white sub-pixel W can be accomplished by a two transistor operation, thereby preventing two adjacent sub-pixels from shielding and increasing the aperture ratio of display panel. Further, according to some embodiments of the disclosure, the area of the first color sub-pixel, the area of the second color sub-pixel, the area of the third color sub-pixel, and the area of the fourth color sub-pixel can be different from each other.

When the low color shift structure of the white sub-pixel (the white sub-pixel W is divided into a bright region W1 and a dark region W2) of the WRGB display panel is accomplished by a charge-sharing operation (CS-type), the bright region W1 and the dark region W2 can be horizontally adjacent to each other (i.e. the boundary between the bright region W1 and the dark region W2 is data signal line). Further, in another embodiment, the bright region W1 and the dark region W2 can also be perpendicularly adjacent to each other. Particularly, the display panel has a higher aperture ratio when the bright region W1 and the dark region W2 is horizontally adjacent to each other.

Moreover, when the low color shift structure of the white sub-pixel (the white sub-pixel W is divided into a bright region W1 and a dark region W2) of the WRGB display panel is accomplished by a two transistor operation (TT-type), the design of the white sub-pixel can be a 2D1G or a 2G1D, wherein the 2D1G structure means each pixel region has two data signal lines and one gate signal line, and the 2G1D structure means each single pixel region has one data signal line and two gate signal lines. In the TT-type, the WRGB sub-pixels can be preferably arranged to form a strip arrangement for increasing the aperture ratio.

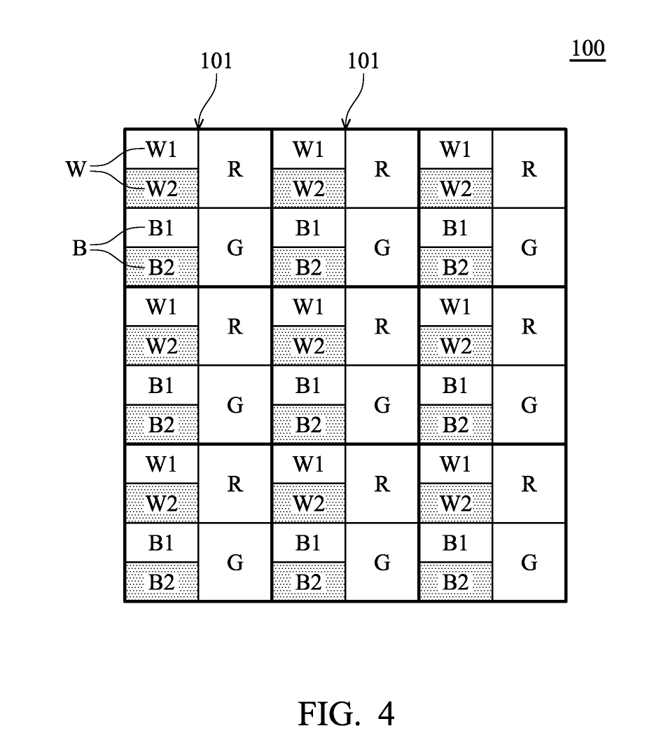

According to another embodiment of the disclosure, in addition to the white sub-pixel (first color sub-pixel) of the pixel 101, other sub-pixels (such as a second color sub-pixel) can also be applied to the low color shift structure design. Please refer to FIG. 4, wherein the white sub-pixel Wand blue sub-pixel B of the WRGB display panel 100 respectively has a low color shift structure. Namely, the white sub-pixel W is divided into a bright region W1 and a dark region W2, and the blue sub-pixel B is divided into a bright region B1 and a dark region B2. According to an embodiment of the disclosure, when the white sub-pixel W and the blue sub-pixel B of the display panel 100 are a TT-type low color shift structure and the sub-pixels can be arranged to form a square arrangement, the white sub-pixel W and the blue sub-pixel B of the display panel 100 can be horizontally or perpendicularly adjacent to each other.

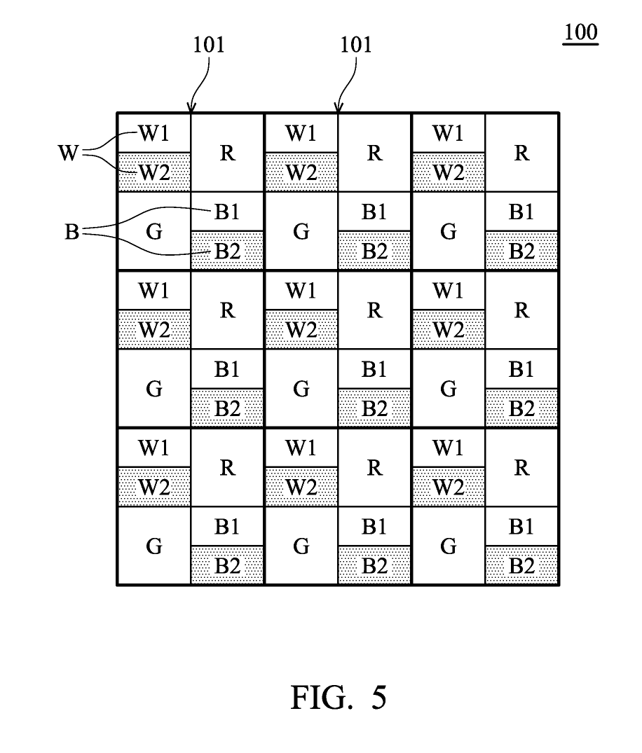

According to another embodiment of the disclosure, referring to FIG. 5, when the white sub-pixel W and the blue sub-pixel B of the display panel 100 are a CS-type low color shift structure and the sub-pixels can be arranged to form a square arrangement, the white sub-pixel W and the blue sub-pixel B of the display panel 100 can be disposed diagonally.

According to some embodiments of the disclosure, the white sub-pixel W and the red sub-pixel R, or the white sub-pixel W and the green sub-pixel G of the WRGB display panel 100 can be applied to the low color shift structure. When the WRGB display panel 100 includes two sub-pixels having the low color shift structure, one of the two sub-pixels must be the white sub-pixel W, and the other sub pixel having the low color shift structure can be the blue sub-pixel B, red sub-pixel R, and green sub-pixel G. In order to display a complexion image, the other sub pixel having the low color shift structure can be the blue sub-pixel B, red sub-pixel R, or green sub-pixel G, in the preferable order. Further, in order to display a yellow-green color image, the other sub pixel having the low color shift structure can be the blue sub-pixel B, red sub-pixel R, or green sub-pixel G, in the preferable order. Moreover, in order to display a blue color image, the other sub pixel having the low color shift structure can be the red sub-pixel R, green sub-pixel G, or blue sub-pixel B, in the preferable order.

When the WRGB display panel includes the blue sub-pixel B and the white sub-pixel W having a low color shift structure, the color hue when viewed from a side of the display panel is greatly improved since the gamma curve of the blue sub-pixel B is within a wide margin of variation when viewed from a side. Further, the complexion image can be optimized by modifying the gamma curve of the blue sub-pixel B via the low color shift structure.

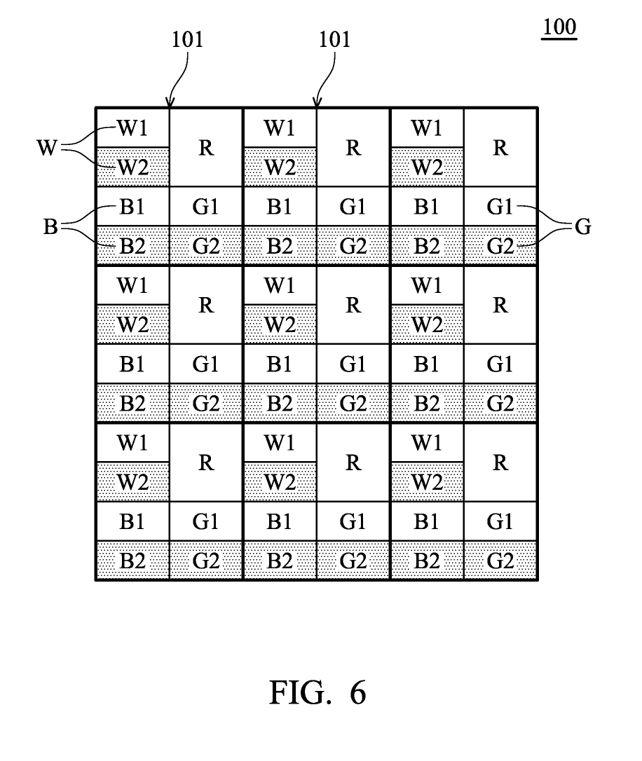

According to some embodiments of the disclosure, the WRGB display panel 100 can include three sub-pixels, among the white sub-pixel, the red sub-pixel, the green sub-pixel, and the blue sub-pixel, having the low color shift structure. One of the three sub-pixels must be a white sub-pixel W (divided into a bright region W1 and a dark region W2), and the others can be a blue sub-pixel B (a bright region B1 and a dark region B2) and a green sub-pixel G (a bright region G1 and a dark region G2). Please refer to FIG. 6, wherein according to some embodiments of the disclosure, the three sub-pixels having the low color shift structure of the WRGB display panel 100 can be a white sub-pixel W, a blue sub-pixel B, and a red sub-pixel R. On the other hand, the three sub-pixels having the low color shift structure of the WRGB display panel 100 can be a white sub-pixel W, a green sub-pixel G, and a red sub-pixel R.

Table 1 shows the brightness and color hue comparisons between the conventional display panel and the display panel of the disclosure. As shown in Table 1, a RGB display panel with no sub-pixel having the low color shift structure exhibits a color hue shifting improvement, which is defined as an expression score of 0. Further, the RGB display panel as shown in FIG. 1 with all sub-pixels having the low color shift structure exhibit a color hue shifting improvement, which is defined as an expression score of 100.

The display panel as shown in FIG. 2 including a white sub-pixel having the low color shift structure has an expression score of color hue shifting improvement in the range of between 40 and 85 when viewed from a side. Although the conventional display panel as shown in FIG. 1 has a color hue shifting improvement that is better than that of the display panel of the disclosure, the color hue shifting improvement of the display panel of the disclosure meets or exceeds a minimum requirement of color hue shifting improvement for a liquid crystal display.

It should be noted that, the amount of semiconductor elements (such as thin film transistors, gate lines, data lines, and/or capacitors) of the display panel of the disclosure can be reduced to one-half or even three-quarter of the amount of semiconductor elements of the WRGB display panel with all sub-pixels having the low color shift structure. Therefore, the display panel of the disclosure has a high aperture ratio resulting in a reduced brightness loss, and a low process complexity resulting in an improved yield and a reduced cost.

Accordingly, one of key features of the disclosure is that at least one sub-pixel of the white sub-pixel, the red sub-pixel, the green sub-pixel, and the blue sub-pixel does not have to be applied to the low color shift structure. For example, the low color shift structure is only applied to a part of the sub-pixels (such as white and/or blue sub-pixels. Although the relative expression score of the display panel of the disclosure (when viewed from a side) is lower than that of the display panel with all WRGB sub-pixels having the low color shift structure, the display panel of the disclosure further has increased advantages such as a higher brightness, an improved yield and a reduced cost.

TABLE 1

| | display | | | display | |
|---|---|---|---|---|---|
| | panel with | display | display | panel with | |
| | RGB sub- | panel with | panel with | WRGB sub- | display panel with |
| | pixels (all | RGB sub- | WRGB sub- | pixels (only | WRGB sub-pixels |
| | sub-pixels | pixels (all | pixels (all | white sub- | (only white sub- |
| | without | sub-pixels | sub-pixels | pixel has | pixel and blue |
| | low color | have low | have low | low color | sub-pixel have |
| | shift | color shift | color shift | shift | low color shift |
| | structure) | structure) | structure) | structure) | structure) |
| Relative | 0 | 100 | 90~100 | 40~60 | 75~85 (remark 1) |
| expression | | | | | |
| score when | | | | | |
| viewed | | | | | |
| from a side | | | | | |
| (complexion) | | | | | |
| Relative | 0 | 100 | 90~100 | 40~60 | 40~60 (remark 2) |
| expression | | | | | |
| score when | | | | | |
| viewed | | | | | |
| from a side | | | | | |
| (RGB color) | | | | | |
| Brightness | — | <−12.6% | −12.6% | −3.4% | −8.66% |
| loss due to | (C-S type) | (C-S type) | (T-T type) | (remark 3) | (remark 3) |
| the reduced | | | | (C-S type) | (T-T type) |
| aperture | | | | | |
| ratio | | | | | |
| (in white | | | | | |
| balance) | | | | | |

Remark 1: measured by advanced algorithm

Remark 2: measured by advanced algorithm and blue LCS bypass

Remark 3: on the premise that the brightness of the white sub-pixel is 1.13 times than that of RGB sub-pixels

The following examples are intended to illustrate the invention more fully without limiting their scope, since numerous modifications and variations will be apparent to those skilled in this art.

### EXAMPLE 1

WRGB display panel with white sub-pixel having the low color shift structure accomplished by a charge-sharing operation

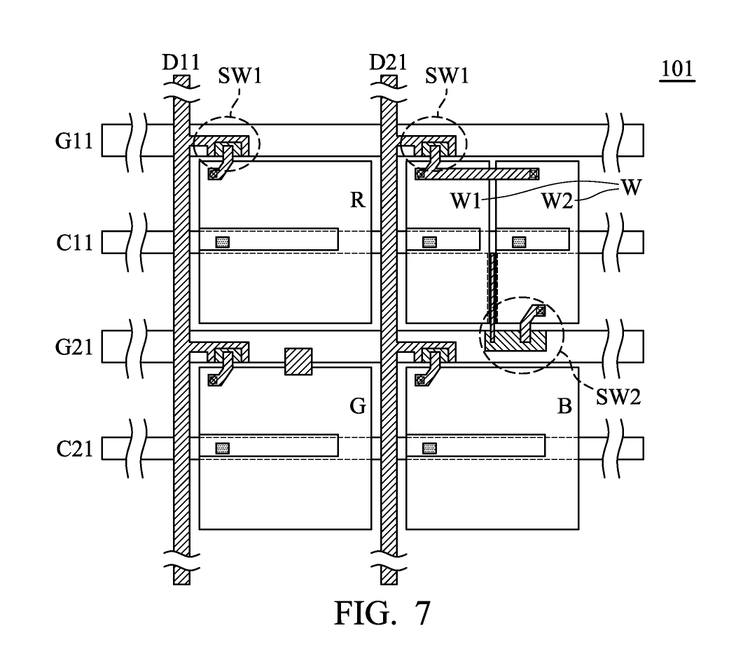

FIG. 7 is a layout diagram of the pixel 101 of the WRGB display panel according to Example 1 of the disclosure. The pixel 101 includes a red sub-pixel R, a green sub-pixel G, a blue sub-pixel B, and a white sub-pixel W arranged to form a square arrangement. The pixel 101 has an active matrix driving circuit for controlling the sub-pixels. The active matrix driving circuit includes data signal lines D11 and D21, gate signal lines G11 and G21, and common lines C11 and C21, wherein the data signal lines are perpendicular to the gate signal lines and the common lines. Each sub-pixel has a thin film transistor SW1 serving as a switch.

Particularly, the white sub-pixel W of the display panel has the low color shift structure accomplished by a charge-sharing operation, and is divided into a bright region W1 and a dark region W2. The bright region W1 and the dark region W2 is horizontally adjacent to each other (i.e. the boundary between the bright region W1 and the dark region W2 is parallel to data signal line). A thin film transistor SW2 is disposed on the gate signal line G21 to electrically couple with the electrode of the dark region W2.

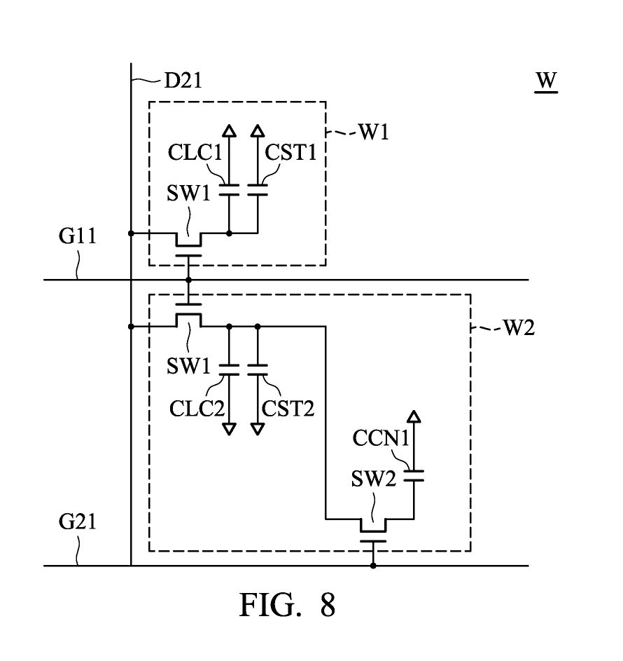

FIG. 8 is an equivalent circuit diagram of the white sub-pixel W of the pixel 101 shown in FIG. 7. The white sub-pixel W includes a bright region W1 and a dark region W2. In the bright region W1, the thin film transistor SW1 is turned-on in response to the gate pulse transmitted via the gate signal line G11. Herein, the source voltage transmitted via the data signal line D21 is stored in the storage capacitor CST1 and the liquid crystal capacitor CLC1. On the other hand, the thin film transistor SW1 of the dark region W2 is tuned on simultaneously, and the source voltage transmitted is also stored in the storage capacitor CST2 and the liquid crystal capacitor CLC2.

After the bright region W1 and the dark region W2 load the source voltage, the thin film transistors SW1 are tuned off. Herein, the dark region W2 has a brightness equal to the bright region W1. Next, the thin film transistor SW2 is tuned on in response to the gate pulse transmitted via the gate signal line G21. Since there is a voltage difference between the liquid crystal capacitor CLC2 and the compensation capacitor CCN1 and there is a voltage difference between the storage capacitor CST2 and the compensation capacitor CCN1, the charges stored in the liquid crystal capacitor CLC2 and the storage capacitor CST2 are shared with the compensation capacitor CCN1, resulting in the brightness of the dark region W2 being less than that of the bright region W1.

Therefore, the white sub-pixel W mixes colors based on different transmittance variations of the bright region W1 and the dark region W2, so as to equate the transmittance variations when viewed from a side viewing angle and from a front, thereby improving the color shift phenomenon and increasing the color saturation.

### EXAMPLE 2

WRGB display panel with white sub-pixel and blue sub-pixel having the low color shift structure accomplished by a two transistor operation (2D1G)

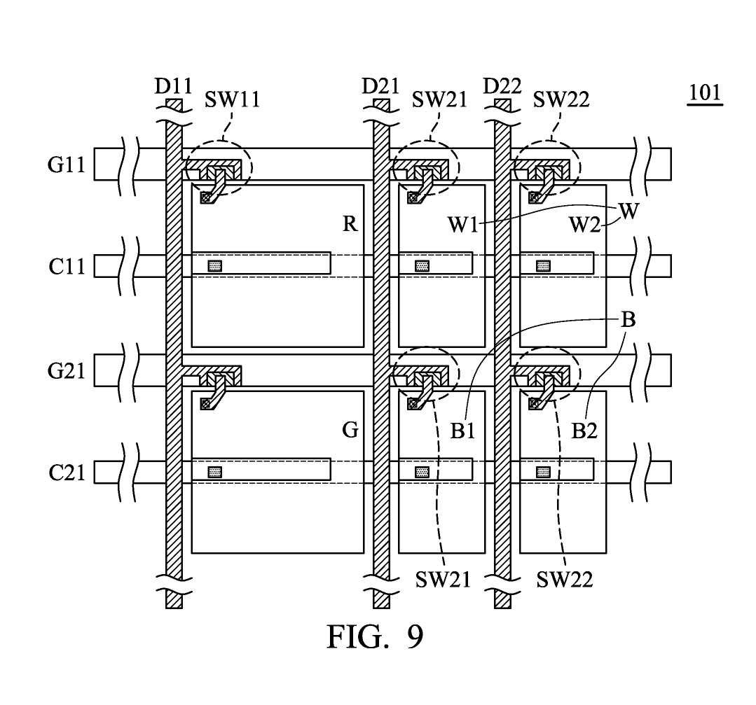

FIG. 9 is a layout diagram of the pixel 101 of the WRGB display panel according to Example 2 of the disclosure. The pixel 101 includes a red sub-pixel R, a green sub-pixel G, a blue sub-pixel B, and a white sub-pixel W arranged to form a square arrangement. The pixel 101 has an active matrix driving circuit for controlling the sub-pixels. The active matrix driving circuit includes data signal lines D11 and D21, gate signal lines G11 and G21, and common lines C11 and C21, wherein the data signal lines are perpendicular to the gate signal lines and the common lines. The red sub-pixel R and the green sub-pixel G have a thin film transistor SW11 serving as a switch respectively. Particularly, the white sub-pixel W of the display panel has the low color shift structure accomplished by a two transistor operation, and is divided into a bright region W1 and a dark region W2, wherein the low color shift structure includes one gate signal line and two data signal line (2D1G), and the blue sub-pixel B of the display panel has the low color shift structure accomplished by a two transistor operation, and is divided into a bright region B1 and a dark region B2, wherein the low color shift structure includes one gate signal line and two data signal line (2D1G). Particularly, the bright region W1 of the white sub-pixel W is controlled by the thin film transistor SW21, and the dark region W2 of the white sub-pixel W is controlled by the thin film transistor SW22, and the bright region B1 of the blue sub-pixel B is controlled by the thin film transistor SW21, and the dark region B2 of the blue sub-pixel B is controlled by the thin film transistor SW22.

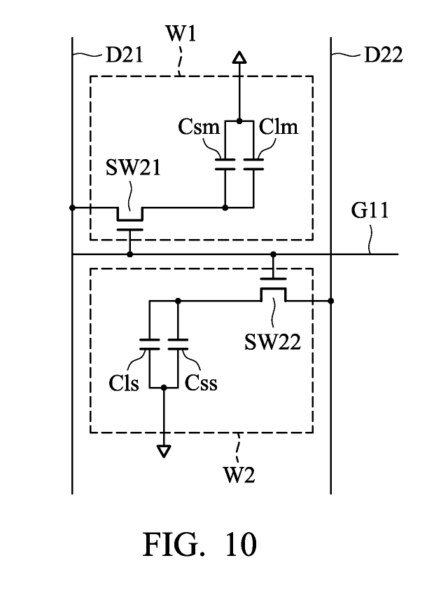

FIG. 10 is an equivalent circuit diagram of the white sub-pixel W of the pixel 101 shown in FIG. 9, wherein the white sub-pixel W is divided into a bright region W1 and a dark region W2. The bright region W1 includes a thin film transistor SW21, and the dark region W2 includes a thin film transistor SW22. The drain electrode of the thin film transistor SW21 is electrically coupled with a storage capacitor Csm and a liquid crystal capacitor Clm, and the drain electrode of the thin film transistor SW22 is electrically coupled with a storage capacitor Css and a liquid crystal capacitor Cls. In the bright region W1, the data signal line D21 is electrically coupled with the source electrode of the thin film transistor SW21. In the dark region W2, the data signal line D22 is electrically coupled with the source electrode of the thin film transistor SW22. The data signal line D21 and the data signal line D22 provide different source voltages respectively, resulting in the brightness of the bright region W1 being larger than that of the dark region W2.

Further, the bright region W1 and the dark region W2 share the gate signal line G11 electrically connecting to the gate electrodes of the thin film transistors SW21 and SW22. Accordingly, the bright region W1 and the dark region W2 can be controlled respectively by the thin film transistors SW21 and SW22. Therefore, the white sub-pixel W mixes colors based on different transmittance variations of the bright region W1 and the dark region W2, so as to equate the transmittance variations when viewed from a side viewing angle and from a front, thereby improving the color shift phenomenon and increasing the color saturation.

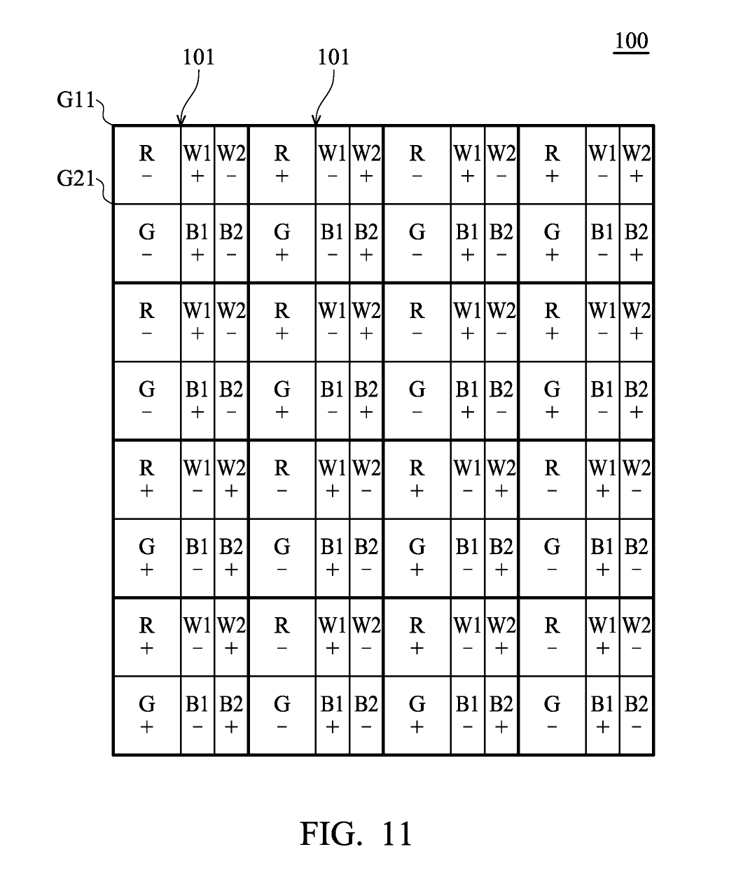

FIG. 11 is a schematic diagram showing the sub-pixel polarity arrangement of the WRGB display panel of Example 2, wherein the symbol “+” indicates a positive polarity sub-pixel, and the symbol “−” indicates a negative polarity sub-pixel. As shown in FIG. 11, the polarity of the bright region W1 of the white sub-pixel W is opposite to the polarity of the dark region W2 of the white sub-pixel W. Meanwhile, the polarity of the bright region B1 of the blue sub-pixel B is opposite to the polarity of the dark region B2 of the blue sub-pixel B. Further, the red sub-pixel R is adjacent to the bright region W1 of the white sub-pixel W along the gate signal line G11, and the polarity of the red sub-pixel R (such as a negative polarity) is opposite to the polarity (such as a positive polarity) of the bright region W1. In some embodiments, the red sub-pixel R is adjacent to the dark region W2, and the polarity of the red sub-pixel R is opposite to the polarity of the dark region W2.

As shown in FIG. 11, the two-line inversion polarity pattern is used for driving the display panel. Further, in some embodiments of the disclosure, the dot inversion polarity pattern or the column inversion polarity pattern can be used for driving the display panel, eliminating the twinkling phenomenon and the grid noises.

### EXAMPLE 3

WRGB display panel with white sub-pixel and blue sub-pixel having the low color shift structure accomplished by a two transistor operation (2G1D)

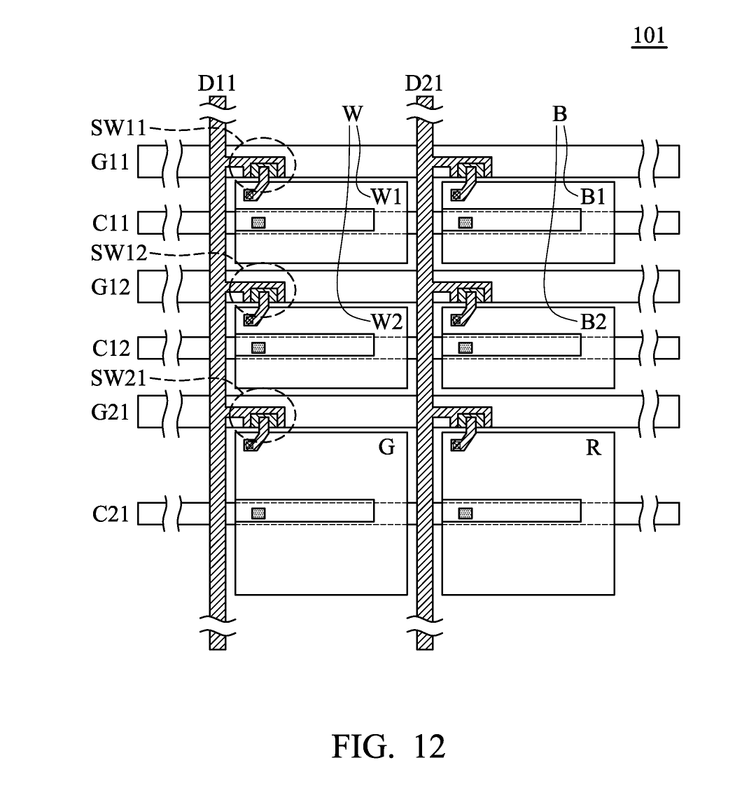

FIG. 12 is a layout diagram of the pixel 101 of the WRGB display panel according to Example 2 of the disclosure. The pixel 101 includes a red sub-pixel R, a green sub-pixel G, a blue sub-pixel B, and a white sub-pixel W arranged to form a square arrangement. The pixel 101 has an active matrix driving circuit for controlling the sub-pixels. The active matrix driving circuit includes data signal lines D11 and D21, gate signal lines G11 and G21, and common lines C11 and C21, wherein the data signal lines are perpendicular to the gate signal lines and the common lines. The red sub-pixel R and the green sub-pixel G have a thin film transistor SW21 serving as a switch respectively.

Particularly, the white sub-pixel W of the display panel has the low color shift structure accomplished by a two transistor operation, and is divided into a bright region W1 and a dark region W2, wherein the low color shift structure includes two gate signal lines and one data signal line (2G1D), and the blue sub-pixel B of the display panel has the low color shift structure accomplished by a two transistor operation, and is divided into a bright region B1 and a dark region B2, wherein the low color shift structure includes two gate signal lines and one data signal line (2G1D). Particularly, the bright region W1 of the white sub-pixel W is controlled by the thin film transistor SW11, and the dark region W2 of the white sub-pixel W is controlled by the thin film transistor SW12, and the bright region B1 of the blue sub-pixel B is controlled by the thin film transistor SW11, and the dark region B2 of the blue sub-pixel B is controlled by the thin film transistor SW12.

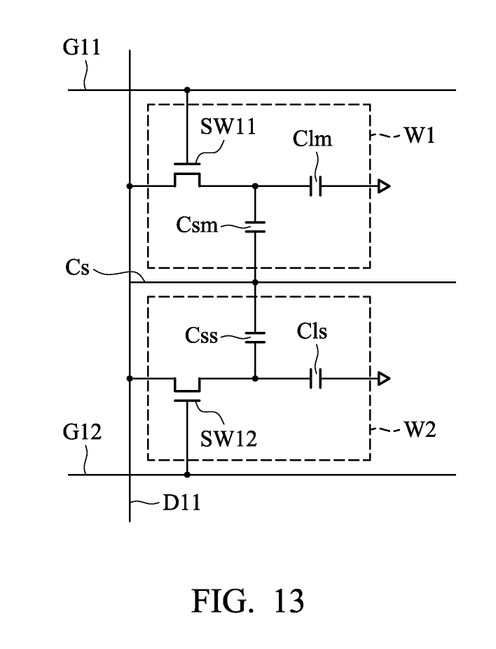

FIG. 13 is an equivalent circuit diagram of the white sub-pixel W of the pixel 101 shown in FIG. 12, wherein the white sub-pixel W is divided into a bright region W1 and a dark region W2. The bright region W1 includes a thin film transistor SW11, and the dark region W2 includes a thin film transistor SW12. The drain electrode of the thin film transistor SW12 is electrically coupled with a storage capacitor Css and a liquid crystal capacitor Cls. In the bright region W1, the gate signal line G11 is electrically coupled with the gate electrode of the thin film transistor SW11. In the dark region W2, the gate signal line G12 is electrically coupled with the gate electrode of the thin film transistor SW12. Further, the bright region W1 and the dark region W2 share the data signal line D11 electrically connecting to the source electrodes of the thin film transistors SW11 and SW12. Further, the bright region W1 and the dark region W2 share the storage capacitor line Cs connecting to the storage capacitor Csm of the bright region W1 and the storage capacitor Css of the dark region W2 respectively.

In a first predetermined interval, the thin film transistor SW11 and the thin film transistor SW12 are turned-on simultaneously. Meanwhile, the data signal line D11 provides a first source voltage, and the bright region W1 and the dark region W2 both have a first brightness. In a second predetermined interval, the thin film transistor SW11 is turned-off, and the thin film transistor SW12 is still turned-on. Meanwhile, the data signal line D11 provides a second source voltage, resulting in the dark region W2 having a second brightness different from the first brightness.

Accordingly, the bright region W1 and the dark region W2 can be controlled respectively by the thin film transistors SW11 and SW12. Therefore, the white sub-pixel W mixes colors based on different transmittance variations of the bright region W1 and the dark region W2, so as to equate the transmittance variations when viewed from a side viewing angle and from a front, thereby improving the color shift phenomenon and increasing the color saturation.

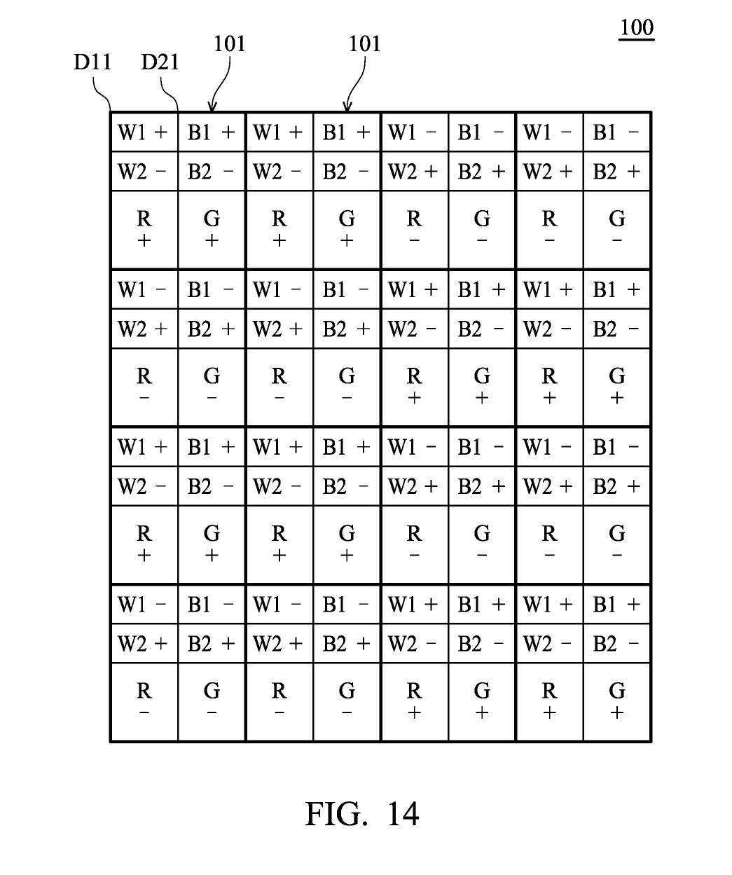

FIG. 14 is a schematic diagram showing the sub-pixel polarity arrangement of the WRGB display panel of Example 3, wherein the symbol “+” indicates a positive polarity sub-pixel, and the symbol “−” indicates a negative polarity sub-pixel. As shown in FIG. 11, the polarity of the bright region W1 of the white sub-pixel W is opposite to the polarity of the dark region W2 of the white sub-pixel W. Meanwhile, the polarity of the bright region W1 of the white sub-pixel W is opposite to the polarity of the dark region W2 of the white sub-pixel W. Further, the red sub-pixel R is adjacent to the dark region W2 of the white sub-pixel W along the data signal line D11, and the polarity of the red sub-pixel R (such as a positive polarity) is opposite to the polarity (such as a negative polarity) of the dark region W2.

As shown in FIG. 14, the two-line inversion polarity pattern is used for driving the display panel. Further, in some embodiments of the disclosure, the dot inversion polarity pattern or the column inversion polarity pattern can be used for driving the display panel, eliminating the twinkling phenomenon and the grid noises.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display panel, comprising:
a plurality of pixels, wherein each pixel comprises a first color sub-pixel, a second color sub-pixel, a third color sub-pixel, and a fourth color sub-pixel, and the first color sub-pixel consists of a bright region and a dark region.

2. The display panel as claimed in claim 1, wherein the bright region and the dark region of the first color sub-pixel are accomplished by a charge-sharing operation

3. The display panel as claimed in claim 1, wherein of the bright region and the dark region of the first color sub-pixel are accomplished by a two transistor operation.

4. The display panel as claimed in claim 1, wherein the first color sub-pixel is a white sub-pixel.

5. The display panel as claimed in claim 1, wherein the second color sub-pixel consists of a bright region and a dark region.

6. The display panel as claimed in claim 5, wherein the second color sub-pixel is a blue sub-pixel.

7. The display panel as claimed in claim 5, wherein a low color shift (LCS) display mode of the second color sub-pixel is controlled to be turned on or turned off according to a desired color grayscale value.

8. The display panel as claimed in claim 1, wherein the fourth color sub-pixel consists of one region, and the fourth color sub-pixel is not divided into a bright region and a dark region.

9. The display panel as claimed in claim 8, wherein the fourth color sub-pixel is not a white sub-pixel.

10. The display panel as claimed in claim 3, wherein the bright region of the first color sub-pixel has a charging polarity opposite to a charging polarity of the dark region of the first color sub-pixel.

11. The display panel as claimed in claim 3, wherein the first color sub-pixel has one gate signal line and two data signal lines.

12. The display panel as claimed in claim 11, wherein the third color sub-pixel is adjacent to the bright region of the first color sub-pixel along the gate signal line direction, and the third color sub-pixel has a charging polarity opposite to a charging polarity of the bright region of the first color sub-pixel.

13. The display panel as claimed in claim 11, wherein the third color sub-pixel is adjacent to the dark region of the first color sub-pixel along the gate signal line direction, and the third color sub-pixel has a charging polarity opposite to a charging polarity of the dark region of the first color sub-pixel.

14. The display panel as claimed in claim 3, wherein the first color sub-pixel has two gate signal lines and one data signal line.

15. The display panel as claimed in claim 14, wherein the third color sub-pixel is adjacent to the bright region of the first color sub-pixel along the data signal line direction, and the third color sub-pixel has a charging polarity opposite to a charging polarity of the bright region of the first color sub-pixel.

16. The display panel as claimed in claim 14, wherein the third color sub-pixel is adjacent to the dark region of the first color sub-pixel along the data signal line direction, and the third color sub-pixel has a charging polarity opposite to a charging polarity of the dark region of the first color sub-pixel.

17. The display panel as claimed in claim 1, wherein the bright region of the first color sub-pixel has an area equal to an area of the dark region of the first color sub-pixel.

18. The display panel as claimed in claim 1,
wherein the bright region of the first color sub-pixel has an area not equal to an area of the dark region of the first color sub-pixel.

19. The display panel as claimed in claim 1, wherein the areas of the first color sub-pixel, the second color sub-pixel, the third color sub-pixel, and the fourth color sub-pixel are equal to each other.

20. The display panel as claimed in claim 1, wherein the first color sub-pixel, the second color sub-pixel, the third color sub-pixel, and the fourth color sub-pixel are arranged to form a square arrangement.
